(19) United States
(12) Patent Application Publication
(10) Pub. No.: US 2008/0072677 A1
(43) Pub. Date: Mar. 27, 2008

(54) Bending mode accelerometer

(76) Inventors: Sorah Rhee, Pennsylvania Furnace, PA (US); Eldon Eller, San Marcos, CA (US)

Correspondence Address: HELLER EHRMAN LLP, 275 MIDDLEFIELD ROAD, MENLO PARK, CA, 94025-3506, US

(21) Appl. No.: 11/535,357

(22) Filed: Sep. 26, 2006

(51) Int. Cl. G01P 15/09

(52) U.S. Cl. 73/652; 73/514.29; 73/514.34

(57) ABSTRACT

A single crystal unimorph based accelerometer has a housing base portion with a base portion bottom surface that includes two separate metallization areas. One of the two separate metallization areas is electrical active. The other is a ground electrical connection. A housing top portion is coupled to the housing base portion. A piezoelectric single crystal is positioned between the housing base portion and the housing top portion. The piezoelectric single crystal has a metal shim that forms a unimorph bonded with a metal loaded electrical conductive epoxy, and forms an electrical connection at a top electroding surface of the piezoelectric single crystal. The piezoelectric single crystal includes a cantilevered free portion that extends to the housing base portion At least a portion of the top electroding surface of the piezoelectric single crystal provides for tuning of capacitance and is an active electrical connection for the unimorph. At least a portion of a bottom surface forms the electrical ground connection. The housing base metallization areas are coupled by an electrical connector to a piezoelectric single crystal electrical connection.

### BACKGROUND

1. Field of the Invention

This invention relates generally to bending mode accelerometers, and their methods of use, and more particularly to bending mode accelerometers, and their methods of use, which incorporate a piezoelectric single crystal as a sensing element.

2. Description of the Related Art

It is known to use piezoelectric accelerometers for measuring the vibrations. Among the known basic principles used for the design of accelerometers, there are two that are the most frequently used, namely, the shear mode design and the compression mode design. The compression mode designs can be split in two subgroups. A first subgroup using a pure compression of a monolithic stack of one or more piezoelectric elements with a coupled seismic mass (d₃₃ mode) in the z-axis whereas a second subgroup uses the bending mode a bending mode element (d₃₁). These two basic designs use none or one seismic mass which, under the effect of an applied force generated by the vibrations, act upon one or more piezoelectric elements inducing the piezoelectric effect of conversion of mechanical energy in to voltage or charge output.

In the shear mode accelerometer design, the piezoelectric element is poled perpendicular to the sensitive axis. The piezoelectric coefficient used for producing the electric charge or voltage is based on the d₁₅ mode of the piezoelectric element.

Each one of these two basic accelerometer designs has advantages and disadvantages for the design such as sensitivity, working frequency range, packaging, and size. Shear mode accelerometers can be used to suppress the influence of the temperature-dependent pyroeffect by using a different sensitive axis than compression mode accelerometers. However, compression mode crystals are easier to fabricate and assemble. Furthermore they are more suitable for high frequency applications than shear mode sensors.

Conventional accelerometers employing cantilever-mounted beams. elements of piezoceramic material are well-known. However, all of these conventional accelerometers are not suitable for SMT. Some of these accelerometers are comparatively large, are overly heavy, or have very little sensitivity which translates into small voltage or charge output. Other types of conventional accelerometers which do not presently suffer from all of the deficiencies of the bending-beam piezoceramic accelerometers are not self-generating, in contrast to the piezoceramic devices. These other conventional accelerometers require additional excitation, control or power supply circuitry which is not required of the piezoceramic devices. They exhibit low output and low sensitivity.

Accordingly, it has become recognized that a small, lightweight, rugged, and reliable accelerometer which is self-generating, employs SMT, and provides a very high charge output is highly desirable. A piezoceramic cantilever beam structure offers a good starting point toward the realization of such an accelerometer. However, all conventional piezoceramic accelerometers suffer from some of the deficiencies outlined above.

There is a need for a piezoceramic bending beam accelerometer which is small, rugged, light weight, reliable, and comparatively inexpensive. There is a further need for a cantilever-beam based accelerometer that employs SMT, and requires no separate lead wires to accomplish its connection to a circuit board.

### SUMMARY

An object of the present invention is to provide an improved bending mode accelerometer, and its associated methods of use.

Another object of the present invention is to provide a bending mode accelerometer, and its methods of use, that is small, rugged, and light weight.

Another objective of the present invention is to provide a bending mode accelerometer, and its methods of used, that provides high signal output in form of charge or voltage.

A further object of the present invention is to provide a bending mode accelerometer, and its methods of use, that is a single crystal unimorph based accelerometer.

Still another object of the present invention is to provide a bending mode accelerometer, and its methods of use that has a compression mode (d₃₁) relaxor-based single crystal.

Another object of the present invention is to provide a bending mode accelerometer, and its methods of use that has a piezoelectric crystal, poled along the crystallographic <110> direction.

Yet a further object of the present invention is to provide a bending-mode accelerometer, and its methods of use that has a PMN-PT or PZN-PT crystal, poled along <110> to optimize the highest (d₃₁) piezoelectric output.

These and other objects of the present invention are achieved in a single crystal unimorph based accelerometer. A housing base portion has a base portion bottom surface that includes two separate metallization areas. One of the two separate metallization areas is the electrically active connection. The other is a ground electrical connection. A housing top portion is coupled to the housing base portion. A piezoelectric single crystal is positioned between the housing base portion and the housing top portion. The piezoelectric single crystal has a metal shim that forms a unimorph bonded with a metal loaded electrical conductive epoxy, and forms an electrical connection at a top electroding surface of the piezoelectric single crystal. The piezoelectric single crystal includes a cantilevered free portion that extends to the housing base portion. At least a portion of the top electroding surface of the piezoelectric single crystal provides for tuning of capacitance and is an active electrical connection for the unimorph. At least a portion of a bottom surface forms the electrical ground connection. The housing base metallization areas are coupled by an electrical connector to a piezoelectric single crystal electrical connection.

In another embodiment of the present invention, a method is provided for measuring vibration. A vibration measuring device with a single crystal based bending mode accelerometer is provided. The accelerometer includes a sub-assembly with a piezoelectric single crystal positioned between a housing base portion and a housing top portion. The piezoelectric single crystal is held vertical by the base portion and bonded to heavy metal masses. The vibration measuring device is in a position to measure vibration at a selected site. The single crystal based leveraged bending mode accelerometer is utilized to measure vibration at the selected site.

### DESCRIPTION OF THE DRAWINGS

FIGS. 1(a) and 1(b) are schematic diagrams of one embodiment of a bending mode accelerometer of the present invention.

### DETAILED DESCRIPTION

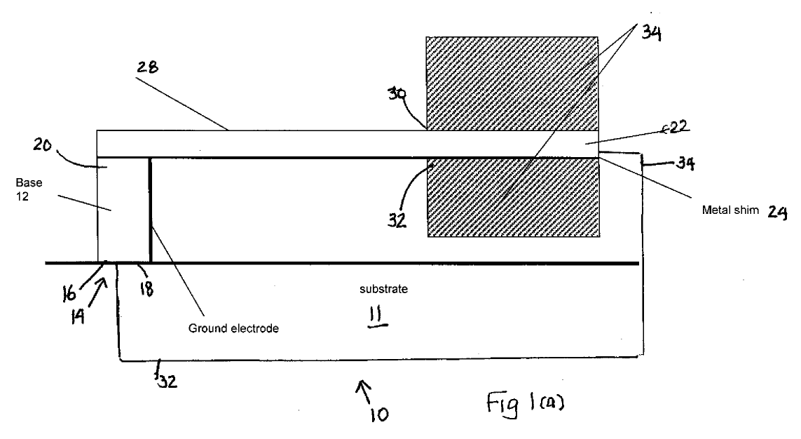

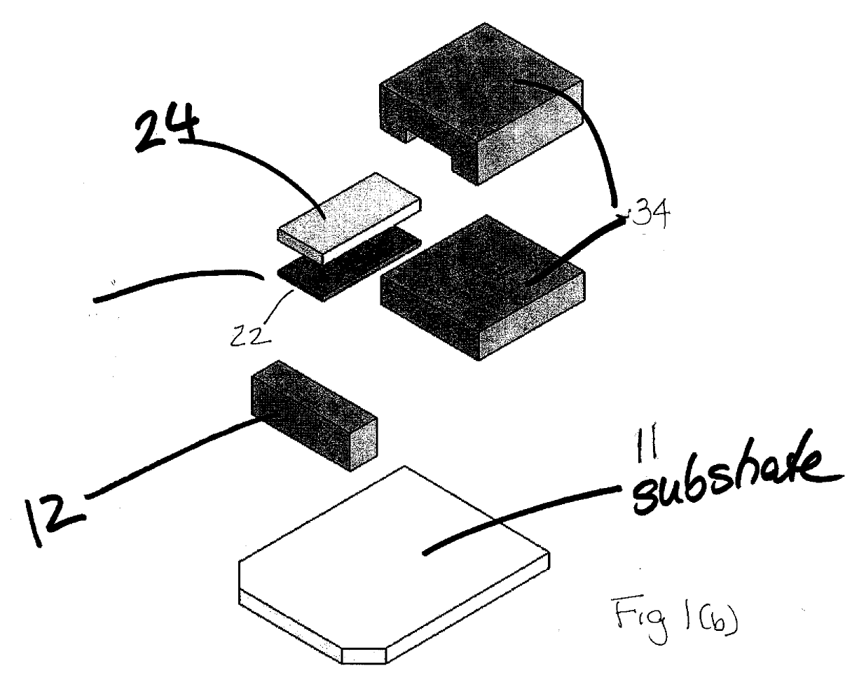

Referring now to FIGS. 1(a)-(b), one embodiment of the present invention is a single crystal unimorph based accelerometer generally denoted as 10 that can be mounted on a ASIC substrate 11. A housing base portion 12 has a base portion bottom surface 14 that includes two separate metallization areas 16 and 18. One of the two separate metallization areas 16 and 18 is electrical active and the other is a ground electrical connection. A housing top portion 20 is coupled to the housing base portion 12.

A piezoelectric single crystal 22 positioned between the housing base portion 12 and the housing top portion 20. The piezoelectric single crystal 22 has a metal shim 24 that forms a unimorph bonded with a metal loaded electrical conductive epoxy 26, and forms an electrical connection at a top electroding surface 28 of the piezoelectric single crystal 22. The piezoelectric single crystal 22 includes a cantilevered free portion 28 that extends to the housing base portion 12. At least a portion of the top electroding surface 28 of the piezoelectric single crystal 22 provides for tuning of capacitance and provides an active electrical connection for the unimorph. At least a portion of a bottom surface 30 forms the electrical ground connection. The housing base metallization areas 16 and 18 are coupled by an electrical connector 32 to a piezoelectric single crystal electrical connection 34.

In one embodiment, the piezoelectric single crystal 22 is a compression mode (d₃₁) relaxor single crystal. In another embodiment, the piezoelectric single crystal 22 is a piezoelectric crystal, poled along <110>. In another embodiment, the piezoelectric single crystal 22 is a PMN-PT or PZN-PT crystal, poled along <110> to optimize the highest (d₃₁) piezoelectric output. In one embodiment, the piezoelectric single crystal 22 senses mechanical vibration in the 50 to 120 Hz range in a z-axial direction.

The base portion can be formed of a metallized ceramic. It will be appreciated that the accelerometer 10 can have different geometric configurations. In one embodiment, the accelerometer 10 is a rectangular prismatic structure.

An end portion of the cantilevered free portion is coupled with two high density metal masses. At least one of the two high density metal masses can be slotted to provide for insertion of the unimorph. The high density metal masses can be bonded to the unimorph with a metal filler loaded epoxy. In one embodiment, the high density metal mass is a metal with a density of at least 17000 kg/m³. The high density metal mass is selected to provide for an optimum mass loading-to-size ratio of the metal mass. This translates into utilizing as much space inside the housing allowing for a maximum of voltage/charge output of the unimorph sensing element of the accelerometer.

In one embodiment, the high density metal mass is tungsten. Other suitable metals include, but are not limited to, molybdenum, tantalum, hafnium, gold, platinum, ruthenium, iridium, palladium, renium, lanthanum metals, actinum metals., and the like.

In one embodiment, the accelerometer has a high voltage output. The high voltage output can be greater than 200 mV/g).

The accelerometer 10 can be included in a vibration measuring device that measures vibration. Suitable vibration measuring devices include but are not limited to, a cardiac rhythm management device, a cardiac monitoring device a neurostimulation device, a neurosignal generating device, interruption or blocking device, a clamp style ablation device, an internal catheter based ablation device, an external or internal measuring device for blunt force trauma to the body, a device for measuring external forces on the head mounted internally or externally, a body motion tilt sensing device, a device for measuring vibration, forces on, and movement of prosthetic limbs, and the like.

In one embodiment, the accelerometer 10 is configured to measure vibration at a frequency under resonance. In one embodiment, the accelerometer is configured to measure vibration in a range of 100 Hz to 2,500 Hz. When the vibration measuring device is a cardiac rhythm management device, the accelerometer 10 measures vibration of 20-200 Hz.

In one embodiment of a method of the present invention, the vibration measuring device is placed in a position to measure vibration at a selected site. Different types of sites can include, but are not limited to, the torso body cavity, the chest cavity inhabited by the heart, the back cavity inhabited by the spinal cord, the torso body cavities that are inhabited by organs that may require or be receptive to drug therapies, the ear canal, the external torso area, and external limb sites including the arms and legs, and the like. The accelerometer 10 measures vibration at the selected site.

The accelerometer 10 can be adhesively secured and electrically connected to pads on the ASIC substrate 11 by a conductive epoxy and structural epoxy between the pads and the metallization areas 16 and 18 . When acceleration is applied to the ASIC substrate 11 along a vector perpendicular thereto, the piezoelectric single crystal 22 flexes in response to the acceleration force.

The accelerometer 10 has a low capacitance. As can easily be appreciated, the piezoelectric single crystal 22 provides electrical charge in response to stressing of the piezoceramic portions thereof. In one embodiment, the accelerometer 10 has an internal capacitance of about 50 pF, with a charge sensitivity to acceleration along the principle is of 200 mV/G. This combination of charge sensitivity and low internal capacitance results in an electrical output from the accelerometer 10 which is easily accommodated by measurement circuitry external to the accelerometer 10.

### EXAMPLE 1

In this example, the single crystal unimorph based accelerometer 10 is included in a cardiac rhythm management device. the piezoelectric single crystal 22 is a compression mode (d₃₁) relaxor single crystal. The cardiac rhythm management device is designed to deliver an electrical signal to the heart muscle to regulate and control the heart beat rate. Certain inherent physical conditions, external conditions, and physical activities can cause the heart to beat at a rate lower than desired, as well as at a rate higher than desired. The single crystal unimorph based accelerometer 10 is capable of sensing the heart beat rate, and provides an electrical signal to the cardiac rhythm management device proportional to the heart beat rate. The cardiac rhythm management device uses this information to adjust its output to the heart muscle to correctly regulate or maintain the desire heart beat rate. Different cardiac rhythm management devices can also focus on regulation or control of the beat rate of specific chambers of the heat. Information from the single crystal unimorph based accelerometer 10 can also be used for these devices.

The single crystal unimorph based accelerometer 10 is mounted inside of a hermetically sealed enclosure of typically titanium material that houses the other components, battery, printed circuit boards, electrical lead connections, software storage devices, and operational logic devices that comprise a complete cardiac rhythm management device.

### EXAMPLE 2

In this example, the single crystal unimorph based accelerometer 10 is used to measure vibration at a frequency under resonance. Vibrations can be measured in the range of 100 Hz up to 2,500 Hz.

The foregoing description of embodiments of the present invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A single crystal unimorph based accelerometer, comprising:
a housing base portion with a base portion bottom surface that includes two separate metallization areas, one of the two separate metallization areas being electrical active and the other being a ground electrical connection;
a housing top portion coupled to the housing base portion;
a piezoelectric single crystal positioned between the housing base portion and the housing top portion, the piezoelectric single crystal having a metal shim that forms a unimorph bonded with a metal loaded electrical conductive epoxy and forms an electrical connection at a top electroding surface of the piezoelectric single crystal, the piezoelectric single crystal including a cantilevered free portion that extends to the housing base portion, at least a portion of the top electroding surface of the piezoelectric single crystal providing for tuning of capacitance and providing an active electrical connection for the unimorph, at least a portion of a bottom surface forming the electrical ground connection; and
wherein the housing base metallization areas are coupled by an electrical connector to a piezoelectric single crystal electrical connection.

2. The accelerometer of claim 1, wherein the piezoelectric single crystal is a compression mode (d₃₁) relaxor-based single crystal.

3. The accelerometer of claim 1, wherein the piezoelectric single crystal is a piezoelectric crystal, poled along the crystallographic <110> direction.

4. The accelerometer of claim 1, wherein the piezoelectric single crystal is a PMN-PT or PZN-PT crystal, poled along <110> to optimize the highest (d₃₁) piezoelectric output.

5. The accelerometer of claim 1, wherein the piezoelectric single crystal senses mechanical vibration in the 50 to 120 Hz range in a z-axial direction.

6. The accelerometer of claim 1, wherein the base portion is formed of metallized ceramic.

7. The accelerometer of claim 1, wherein the accelerometer is a rectangular prismatic structure.

8. The accelerometer of claim 1, wherein an end portion of the cantilevered free portion is coupled with two high density metal masses, at least one of the two high density metal masses being slotted to provide for insertion of the unimorph.

9. The accelerometer of claim 8, wherein the high density metal masses is bonded to the unimorph with a metal filler loaded epoxy.

10. The accelerometer of claim 8, wherein the high density metal mass is a metal with at least 17000 kg/m³ density. Other suitable metals include (but are not limited to) molybdenum, tantalum, hafnium, gold, platinum, ruthenium, iridium, palladium, renium, lanthanum metals, and actinum metals.

11. The accelerometer of claim 8, wherein the high density metal mass is selected to provide for an optimum mass loading-to-size ratio of the metal mass.

12. The accelerometer of claim 8, wherein the high density metal mass is tungsten.

13. The accelerometer of claim 1, wherein the accelerometer has a high voltage output.

14. The accelerometer of claim 1, wherein the accelerometer has a high voltage output of greater than 200 mV/g.

15. The accelerometer of claim 1, wherein the accelerometer is included in a device that measures vibration.

16. The accelerometer of claim 1, wherein the accelerometer is configured to measure vibration at a frequency under resonance.

17. The accelerometer of claim 16, wherein the accelerometer is configured to measure vibration in a range of 100 Hz to 2,500 Hz.

18. The accelerometer of claim 1, wherein the accelerometer is included in a cardiac rhythm management device.

19. The accelerometer of claim 18, wherein the accelerometer is configured to measure vibration of about 200 Hz.

20. The accelerometer of claim 1, wherein the accelerometer is included in a cardiac monitoring device.

21. A method of measuring vibration, comprising:
providing a vibration measuring device that includes single crystal unimorph based accelerometer with a piezoelectric single crystal positioned between a housing base portion and a housing top portion, the piezoelectric single crystal having a metal shim that forms a unimorph bonded with a metal loaded electrical conductive epoxy and forms an electrical connection at a top electroding surface of the piezoelectric single crystal, the piezoelectric single crystal including a cantilevered free portion that extends to the housing base portion, at least a portion of the top electroding surface of the piezoelectric single crystal providing for tuning of capacitance and providing an active electrical connection for the unimorph;
positioning the vibration measuring device in a position to measure vibration at a selected site; and
utilizing the single crystal unimorph based accelerometer to measure vibration at the selected site.

22. The method of claim 21, wherein the vibration is measured at a frequency under resonance.

23. The method of claim 21, wherein the vibration is measured in a range of 100 Hz to 2,500 Hz.

24. The method of claim 21, wherein the vibration is measured in a range of 20 to 160 Hz range in a z-axial direction.

25. The method of claim 21, wherein the vibration measuring device is included in a cardiolac rhythm management device.

26. The method of claim 21, wherein the selected site is a human chest cavity.

27. The accelerometer of claim 26, wherein the accelerometer is configured to measure vibration of about 200 Hz.

28. The method of claim 21, wherein the piezoelectric single crystal is a compression mode (d₃₁) relaxor single crystal.

29. The method of claim 21, wherein the piezoelectric single crystal is a piezoelectric crystal, poled along <110>.

30. The method of claim 1, wherein the piezoelectric single crystal is a PMN-PT or PZN-PT crystal, poled along <110> to optimize the highest (d₃₁) piezoelectric output.
